(19) United States
(12) Patent Application Publication
(10) Pub. No.: US 2010/0130385 A1
(43) Pub. Date: May 27, 2010

(54) PRODUCTION AND USE OF PARAFFIN INHIBITOR FORMULATIONS

(75) Inventors: Marcus Guzmann, Mühlhausen (DE); Yaqian Liu, Ludwigshafen (DE); Rouven Konrad, Mörstadt (DE); Diana Franz, Schifferstadt (DE)

Correspondence Address: CONNOLLY BOVE LODGE & HUTZ LLP, P.O. BOX 2207, WILMINGTON, DE, 19899, US

(73) Assignee: BASF SE, Ludwigshafen (DE)

(21) Appl. No.: 12/595,422

(22) PCT Filed: Apr. 10, 2008
(86) PCT No.: PCT/EP2008/054343

§ 371 Date: Oct. 9, 2009

(30) Foreign Application Priority Data
Apr. 13, 2007 (EP) 07106132.9

(51) Int. Cl. C09K 8/524

(52) U.S. Cl. 507/90

(57) ABSTRACT

A process for preparing a paraffin inhibitor formulation comprising (a) preparing a mixture comprising a waxy paraffin inhibitor component having a melting point of >0° C. and an emulsifier component, wherein the mixture is prepared at a first temperature range above the melting point of the waxy paraffin inhibitor; (b) adding water to the mixture to produce an o/w emulsion; and (c) cooling the o/w emulsion to a temperature in a second temperature range which is below the melting point of the waxy paraffin inhibitor. The mixture prepared in step (a) may further comprise water to produce a w/o emulsion, the water being present in a proportion by weight that is lower than the sum of the proportions by weight of the paraffin inhibitor and the emulsifier component. The process may further comprise (d) adding an at least partially water-miscible organic solvent in which the paraffin inhibitor is insoluble.

### CROSS-REFERENCE TO RELATED APPLICATIONS

This application is a national stage application (under 35 U.S.C. §371) of PCT/EP2008/054343, filed Apr. 10, 2008, which claims benefit of European application 07106132.9, filed Apr. 13, 2007.

### FIELD OF THE INVENTION

The present invention relates to paraffin inhibitor formulations, to their preparation, to their use and to processes for paraffin inhibition/pour point depression with the aid of such formulations.

### BACKGROUND OF THE INVENTION

In the course of oil production, temperature and pressure changes result in the crystallization of paraffin molecules, which are a constituent of the crude oil and of the crude oil raffinates. Owing to this crystallization process, these paraffins can be deposited in production bores, delivery probes, pipelines or plant parts, such as tanks, which can be disadvantageous for the productivity in the oil extraction and in the oil storage or the transport.

Moreover, the crystallization of the paraffin molecules when the temperature goes below the pour point leads to the solidification of the crude oil. In that case, the oil can no longer be transported, which has the consequence that the oil production can come to a standstill.

To prevent such paraffin deposits or the solidification of the oil, generally paraffin inhibitors or pour point depressants are added to the corresponding systems. In general, the paraffin inhibitors and pour point depressants consist of polymeric structures which have a waxy consistency. Even after mixing of the waxy products with organic solvents, the resulting mixtures are of waxy consistency at low temperature. This is also true of dilute solutions of paraffin inhibitors or pour point depressants.

These waxy products can be applied in different ways.

One possibility consists in melting these waxy products on site and then metering them into the crude oil stream or into the oil plant parts as a melt. The disadvantage of this method is that complicated equipment for melting and dosage has to be kept ready and maintained. In the case of failure of apparatus for melting, such as a heater, the metering of the paraffin inhibitor or pour point depressant is no longer possible, which leads to the above-mentioned problems.

As an alternative, the paraffin inhibitors can be dissolved in solvents and then the finished product can be supplied in the form of a solution. Such a procedure is described, for example, in WO-A 00/32720.

In this case, however, the paraffin inhibitors are soluble only in a low concentration or the solution as such has a very high viscosity. This is the case especially at low temperatures at which the formulated polymers are no longer soluble, i.e. they either precipitate out or the products become solid.

For countries such as Russia, for example, it is necessary that products should also still be liquid and meterable even at −50° C.

There is therefore a need for suitable formulations which comprise paraffin inhibitors which do not have at least some of the disadvantages described above.

### BRIEF SUMMARY OF THE INVENTION

It is thus an object of the present invention to provide a paraffin inhibitor formulation and process for its preparation, which at least partly avoids the abovementioned disadvantages.

The object is achieved by a process for preparing a paraffin inhibitor formulation, comprising the steps of
(a) obtaining a mixture comprising
   (i) a waxy paraffin inhibitor component having a melting point of >0° C.;
   (ii) an emulsifier component and
   (iii) if appropriate water
      at a temperature in a first temperature range, the first temperature range being above the melting point of component (i) and the water, if present, affording a w/o emulsion and having a proportion by weight which is lower than the sum of the proportions by weight of components (i) and (ii);
(b) adding water to the mixture, an o/w emulsion being present after complete addition of the water;
(c) cooling the o/w emulsion from step (b) to a temperature in a second temperature range which is below the melting point of component (i); and
(d) if appropriate adding an at least partly water-miscible organic solvent component (iv) in which the paraffin inhibitor component is insoluble.

The present object is likewise achieved by a paraffin inhibitor formulation obtainable from the preparation process according to the invention.

This is because it has been found that, from the basis of the preparation process according to the invention, it is possible to obtain a formulation which comprises the paraffin inhibitor component in fine and stable distribution, which is promoted by the emulsifier component.

In this way, it is possible to obtain a paraffin inhibitor formulation which has a comparatively high content of paraffin inhibitor component, such that the formulation can be stored and transported in a space-saving manner, and simple metering-in is additionally enabled. In addition, phase separation can be prevented, which leads to an increased storage stability.

The solids content of the formulation to be employed can be established individually by subsequent water addition or by addition of an at least partly water-miscible organic solvent component (IV) in which the paraffin inhibitor component is insoluble.

Furthermore, the pour point of the paraffin inhibitor or pour point depressant formulation can itself be adjusted by adding the organic solvent component (IV), and it is possible to maintain a pour point of down to −50° C.

### DETAILED DESCRIPTION OF THE PREFERRED EMBODIMENTS

In the context of the present invention, the term “inhibitor” or “inhibition” is understood to mean that the paraffin crystal formation in oil as such and/or an undesired alignment and/or form of the crystals is avoided or at least reduced. This leads to a reduction in or prevention of the deposition or precipitation of paraffin or to depression of the pour point.

In the process according to the invention for preparing a paraffin inhibitor formulation, a mixture is obtained in step (a), comprising

(i) a waxy paraffin inhibitor component having a melting point of >0° C.

In the context of the present invention, the term “melting point” is also used in a simplifying manner when the paraffin inhibitor component has a melting range, in which case it is that limiting value of the range which allows the component to be present entirely in liquid form or entirely in solid form that constitutes the melting point in the context of the present invention.

In the context of the present invention, the term “waxy” should be understood to the effect that the component (i) has waxy properties. The characteristic features thereof are especially that the substances or substance mixtures melt without decomposing and are comparatively low-viscosity and strongly temperature-dependent in consistency and solubility even above the melting point. This comprises substances or substance mixtures which are of natural, semisynthetic or synthetic origin. In this context, waxes in the narrower sense should, though, not be understood to mean only such waxes. Waxes in the narrower sense are substance mixtures which comprise, as the main component, esters of higher fatty acids with higher primary alcohols.

In addition, it is possible that the paraffin inhibitor component has a plurality of inhibitors, such that several melting points and/or melting ranges are possible. Here too, the component should be present entirely in liquid (molten) or solid form.

For step (a) of the process according to the invention for preparing a paraffin inhibitor formulation, all melting points must be above 0° C.

In addition, the inventive mixture comprises an emulsifier component (ii) which may comprise one or more emulsifiers or surfactants.

Finally, the mixture may already comprise water, in which case the water which may be present has a proportion by weight which is smaller than the sum of the proportions by weight of components (i) and (ii). This serves to ensure that a water-in-oil (w/o) emulsion is initially present before the further water is added in step (b) of the process according to the invention to prepare a paraffin inhibitor formulation.

Typically, the desired amount of water is partly initially charged in order to obtain an emulsion and the remainder is added after the mixture is obtained in step (b) of the process according to the invention to prepare a paraffin inhibitor formulation.

In step (a) of the process according to the invention for preparing a paraffin inhibitor formulation, it is necessary, before performing step (b), that the paraffin inhibitor component is present in the molten state. Therefore, to obtain an emulsion, a corresponding temperature which is above the melting point of the paraffin inhibitor component has to be selected.

A mixture can be obtained in step (a) of the process according to the invention for preparing a paraffin inhibitor formulation, for example, by initially charging a portion of water and then adding the paraffin inhibitor component (i) and the emulsifier component (ii). For the person skilled in the art, it is, however, obvious that another sequence of the individual steps mentioned can also be effected.

The desired temperature can be effected by simple heating before and/or during and/or after the addition of components (i) and (ii). It is not necessary for the temperature to remain constant.

In addition, the formulation may have further constituents which are advantageously present in dissolved form. It is likewise possible that these constituents are not added until a later step. These may be active ingredients required in the production of crude oil, for example corrosion inhibitors or scale inhibitors.

In step (b) of the process according to the invention for preparing a paraffin inhibitor formulation, water is added to the mixture, in which case an oil-in-water (o/w) emulsion is present after complete addition of the water. In this context, it has to be ensured that no precipitations occur. This can be ensured by virtue of the water to be added already having the desired temperature.

Subsequently, in step (c) of the process according to the invention for preparing a paraffin inhibitor formulation, the o/w emulsion thus obtained from step (b) is cooled to a temperature in a second temperature range which is below the melting point of component (i).

As a result, the paraffin inhibitor component solidifies, so that it is present as a finely divided solid in the formulation.

In addition, in a step (d) of the process according to the invention for preparing a paraffin inhibitor formulation, an organic solvent component (iv) which is at least partly water-miscible and in which the paraffin inhibitor component is insoluble can be added. The paraffin inhibitor component should preferably be soluble in component (iv) to an extent of less than 1% by weight. This serves to ensure that the paraffin inhibitor component is still present as a fine distribution of a solid.

The paraffin inhibitor formulation thus obtained thus comprises at least one paraffin inhibitor component (I), an emulsifier component (ii), water and if appropriate an organic solvent component (iv).

As has already been stated above, the paraffin inhibitor formulation may also comprise further constituents which are appropriately present in dissolved form. The organic solvent component (iv) and its content in the formulation can, if appropriate, be selected such that further substances are present in the formulation in dissolved form.

The paraffin inhibitor component (i) may be a paraffin inhibitor known in the prior art or a mixture thereof. Especially polymeric paraffin inhibitors are typically not pure individual compounds. Instead, they are normally, as a result of the preparation, a mixture of very similar individual compounds.

Examples of such inhibitors are polymers based on ethylene/vinyl acetate, acrylic acid, methacrylic acid, olefin/maleic acid or the anhydride thereof or fatty acids which have been reacted with fatty alcohols or amines thereof to give esters, amides or imides.

Further examples of paraffin inhibitors are described by D. Alvares et al., Petroleum Science and Technology 18 (2000), 195-202 and by H. S. Ashbaugh et al., Energy and Fuels 19 (2005), 138-144.

Particularly preferred paraffin inhibitors are branched hydrocarbons which have carboxylate groups which have been esterified partly or fully with a linear paraffin alcohol or mixtures of fatty alcohols. The branched hydrocarbons are preferably copolymers of C₁₀-C₄₀-α-olefins with maleic anhydride having a molecular weight of from 2 to 40 kDa, preferably from 5 to 30 kDa. Also preferred are C₁₂-C₃₀-α-olefins, especially C₂₀-C₂₄-olefins.

The linear paraffin alcohol is preferably a C₁₀-C₄₀-alcohol or a mixture thereof. More preferred are C₁₅-C₃₀-alcohols.

The at least partly esterified polymers preferably have a degree of esterification which depends on the base structure used. It is thus advisable when at least 50% of the carboxylate functions in poly(meth)acrylates and in copolymers comprising maleic anhydride are at least 25% esterified.

As well as the inhibitor itself, the paraffin inhibitor component may comprise further constituents. These may, for example, be solvents. In this context, it is possible in particular to use organic water-immiscible solvents which can also partly dissolve the inhibitor. In the context of the present invention, it is merely necessary that the paraffin inhibitor component has a melting point or melting range as specified above. When the paraffin inhibitor component has a plurality of constituents, it is necessary for the emulsion that all constituents are present in the molten or dissolved state, in which case at least the paraffin inhibitor in the formulation prepared is not present in dissolved form.

The emulsifier component (ii) may comprise one surfactant or a plurality of surfactants (surfactant mixture).

The surfactants used may be anionic, nonionic, amphoteric or cationic. It is also possible to use mixtures of surfactants mentioned. Preferred formulations comprise nonionic surfactants and mixtures thereof with further surfactants.

Useful anionic surfactants are sulfates, sulfonates, carboxylates, phosphates and mixtures thereof. Suitable cations are alkali metals, for example sodium or potassium, or alkaline earth metals, such as calcium or magnesium, and also ammonium, substituted ammonium compounds, including mono-, di- or triethanolammonium cations and mixtures thereof. Amongst the anionic surfactants, preference is given to alkyl ester sulfonates, alkyl sulfates, alkyl ether sulfates, alkylbenzenesulfonates, secondary alkanesulfonates and soaps. These are described below.

Alkyl ester sulfonates include linear esters of C₁₈-C₂₀-carboxylic acids (fatty acids) which are sulfonated by means of gaseous SO₃, as described, for example, in “The Journal of the American Oil Chemists Society” 52 (1975), p. 323-329. Suitable starting materials are natural fats, such as tallow, coconut oil and palm oil, but also fats of a synthetic nature. Preferred alkyl ester sulfonates are compounds of the formula

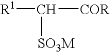

in which R¹ is a C₈-C₂₀-hydrocarbyl radical, preferably alkyl, and R is a C₁-C₆-hydrocarbyl radical, preferably alkyl. M is a cation which forms a water-soluble salt with the alkyl ester sulfonate. Suitable cations are sodium, potassium, lithium or ammonium cations, for example monoethanolamine, diethanolamine and triethanolamine. Preferably, R¹ is C₁₀-C₁₆-alkyl and R is methyl, ethyl or isopropyl. Most preferred are methyl ester sulfonates in which R¹ is C₁₀-C₁₆-alkyl.

Alkyl sulfates are water-soluble salts or acids of the formula ROSO₃M in which R is a C₁₀-C₂₄-hydrocarbyl radical, preferably an alkyl or hydroxyalkyl radical with C₁₀-C₂₀-alkyl component, more preferably a C₁₂-C₁₈-alkyl or hydroxyalkyl radical. M is hydrogen or a suitable cation, for example an alkali metal cation, preferably sodium, potassium, lithium, or an ammonium or substituted ammonium cation, preferably a methyl, dimethyl and trimethylammonium cation or a quaternary ammonium cation, for example the tetramethylammonium and dimethylpiperidinium cations, and quaternary ammonium cations derived from alkylamines such as ethylamine, diethylamine, triethylamine and mixtures thereof.

Alkyl ether sulfates are water-soluble salts or acids of the formula RO(A)ₘ SO₃M in which R is an unsubstituted C₁₀-C₂₄-alkyl or hydroxyalkyl radical, preferably a C₁₂-C₂₀-alkyl or hydroxyalkyl radical, more preferably a C₁₂-C₁₈-alkyl or hydroxyalkyl radical. A is an ethoxy or propoxy unit, m is a number greater than 0, preferably between approx. 0.5 and approx. 6, more preferably between approx. 0.5 and approx. 3, and M is a hydrogen atom or a cation, for example sodium, potassium, lithium, calcium, magnesium, ammonium or a substituted ammonium cation. Examples of substituted ammonium cations comprise methyl-, dimethyl-, trimethylammonium and quaternary ammonium cations, such as tetramethylammonium and dimethylpiperidinium cations, and also those which are derived from alkylamines such as ethylamine, diethylamine, triethylamine or mixtures thereof. Examples include C₁₂-C₁₈ fatty alcohol ether sulfates in which the content of ethylene oxide units is 1, 2, 2.5, 3 or 4 mol per mole of the fatty alcohol ether sulfate and M is sodium or potassium.

In secondary alkanesulfonates, the alkyl group may either be saturated or unsaturated, branched or linear, and may optionally be substituted by a hydroxyl group. The sulfo group may be at any position in the carbon chain, but the primary methyl groups at the start of the chain and at the end of the chain do not have any sulfonate groups. The preferred secondary alkanesulfonates comprise linear alkyl chains having from approx. 9 to 25 carbon atoms, preferably from approx. 10 to approx. 20 carbon atoms and more preferably from approx. 13 to 17 carbon atoms. The cation is, for example, sodium, potassium, ammonium, mono-, di- or triethanolammonium, calcium or magnesium and mixtures thereof. Sodium is the preferred cation.

Further suitable anionic surfactants are alkenyl- or alkylbenzenesulfonates. The alkenyl or alkyl group may be branched or linear and may optionally be substituted by a hydroxyl group. The preferred alkylbenzenesulfonates comprise linear alkyl chains having from approx. 9 to 25 carbon atoms, preferably from approx. 10 to approx. 13 carbon atoms, and the cation is sodium, potassium, ammonium, mono-, di- or triethanolammonium, calcium or magnesium and mixtures thereof.

The term anionic surfactants also includes olefinsulfonates which are obtained by sulfonation of C₁₂-C₂₄-α-olefins, preferably C₁₄-C₁₆-α-olefins, with sulfur trioxide and subsequent neutralization. As a result of the preparation process, these olefinsulfonates may comprise relatively small amounts of hydroxyalkanesulfonates and alkanedisulfonates. Specific mixtures of α-olefinsulfonates are described in U.S. Pat. No. 3,332,880.

Further preferred anionic surfactants are carboxylates, for example fatty acid soaps and comparable surfactants. The soaps may be saturated or unsaturated and may comprise various substituents, such as hydroxyl groups or α-sulfonate groups. Preference is given to linear saturated or unsaturated hydrocarbyl radicals as the hydrophobic moiety having from approx. 6 to approx. 30, preferably from approx. 10 to approx. 18, carbon atoms.

Further useful anionic surfactants include: salts of acylaminocarboxylic acids; the acyl sarcosinates which are formed by reacting fatty acid chlorides with sodium sarcosinate in an alkaline medium; fatty acid/protein condensation products which are obtained by reacting fatty acid chlorides with oligopeptides; salts of alkylsulfamidocarboxylic acids; salts of alkyl and alkylaryl ether carboxylic acids; C₈-C₂₄-olefinsulfonates; sulfonated polycarboxylic acids which are prepared by sulfonation of the pyrolysis products of alkaline earth metal citrates, as described, for example, in GB 1 082 179; alkyl glycerol sulfates; oleyl glycerol sulfates; alkylphenol ether sulfates; primary paraffinsulfonates; alkyl phosphates; alkyl ether phosphates; isethionates, such as acyl isethionates; N-acyltaurides; alkyl succinates; sulfosuccinates; monoesters of sulfosuccinates (particularly saturated and unsaturated C₁₂-C₁₈ monoesters) and diesters of sulfosuccinates (particularly saturated and unsaturated C₁₂-C₁₈ diesters); acyl sarcosinates; sulfates of alkylpolysaccharides, for example sulfates of alkylpolyglycosides, branched primary alkylsulfates and alkylpolyethoxycarboxylates, such as those of the formula RO(CH₂CH₂)ₖCH₂COO⁻M⁺ in which R is C₈- to C₂₋₂-alkyl, k is a number from 0 to 10 and M is a cation; resin acids or hydrogenated resin acids, for example rosin or hydrogenated rosin or tall oil resins and tall oil resin acids. Further examples are described in “Surface Active Agents and Detergents” (Vol. I and II, Schwartz, Perry and Berch).

Examples of useful nonionic surfactants are the following compounds:
Polyethylene, polypropylene and polybutylene oxide condensates of alkylphenols.

These compounds comprise the condensation products of alkylphenols having a C₆-C₂₀-alkyl group which may be either linear or branched with alkene oxides. Preference is given to compounds containing from approx. 5 to 25 mol of alkene oxide per mole of alkylphenol.
Condensation products of aliphatic alcohols with from approx. 1 to approx. 25 mol of ethylene oxide.

The alkyl chain of the aliphatic alcohols may be linear or branched, primary or secondary, and generally comprises from approx. 8 to approx. 22 carbon atoms. Particular preference is given to the condensation products of C₁₀C₂₀-alcohols with from approx. 2 to approx. 18 mol of ethylene oxide per mole of alcohol. The alkyl chain may be saturated or unsaturated. The alcohol ethoxylates may have a narrow homolog distribution (“narrow range ethoxylates”) or a broad homolog distribution of the ethylene oxide (“broad range ethoxylates”).

Examples of commercially available nonionic surfactants of this type are, for example, the Lutensol® brands from BASF Aktiengesellschaft.

Preference is given especially to C₁₆-C₁₈ fatty alcohol ethoxylates as a constituent of component (ii).

Also possible are
Condensation products of ethylene oxide with a hydrophobic base, formed by condensation of propylene oxide with propylene glycol.

The hydrophobic moiety of these compounds preferably has a molecular weight between approx. 1500 and approx. 1800. The addition of ethylene oxide to this hydrophobic moiety leads to an improvement in the solubility in water. The product is liquid up to a polyoxyethylene content of approx. 50% of the total weight of the condensation product, which corresponds to a condensation with up to approx. 40 mol of ethylene oxide. Commercially available examples of this product class are, for example, the Pluronic® brands from BASF Aktiengesellschaft.
Condensation products of ethylene oxide with a reaction product of propylene oxide and ethylenediamine.

The hydrophobic unit of these compounds consists of the reaction product of ethylenediamine with excess propylene oxide and generally has a molecular weight of from approx. 2500 to 3000. Ethylene oxide is added onto this hydrophobic unit until the product has a content of from approx. 40 to approx. 80% by weight of polyoxyethylene and a molecular weight of from approx. 5000 to 11 000. Commercially available examples of this compound class are, for example, the Tetronic® brands from BASF Corp.

Semipolar Nonionic Surfactants

This category of nonionic compounds comprises water-soluble amine oxides, water-soluble phosphine oxides and water-soluble sulfoxides, each having an alkyl radical of from approx. 10 to approx. 18 carbon atoms. Semipolar nonionic surfactants are also amine oxides of the formula

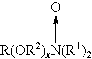

where R is an alkyl, hydroxyalkyl or alkylphenol group with a chain length of from approx. 8 to approx. 22 carbon atoms. R² is an alkylene or hydroxyalkylene group having from approx. 2 to 3 carbon atoms or mixtures thereof, each radical R¹ is an alkyl or hydroxyalkyl group having from approx. 1 to approx. 3 carbon atoms or a polyethylene oxide group having about 1 to about 3 ethylene oxide units, and x is a number from 0 to about 10. The R¹ groups may be joined together via an oxygen or nitrogen atom and thus form a ring. Amine oxides of this type are particularly C₁₀-C₁₈-alkyldimethylamine oxides and C₈-C₁₂-alkoxyethyldihydroxyethylamine oxides.

fatty acid amides

Fatty acid amides have the formula

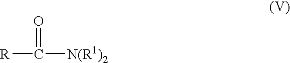

in which R is an alkyl group having from approx. 7 to approx. 21, preferably from approx. 9 to approx. 17, carbon atoms, and R¹ is in each case independently hydrogen, C₁-C₄-alkyl, C₁-C₄-hydroxyalkyl or (C₂H₄O)ₓH where x varies from about 1 to about 3. Preference is given to C₈-C₂₀ amides, monoethanolamides, diethanolamides and isopropanolamides.

Further suitable nonionic surfactants are alkyl- and alkenyloligoglycosides, and also fatty acid polyglycol esters or fatty amine polyglycol esters each having from 8 to 20, preferably from 12 to 18, carbon atoms in the fatty alkyl radical, alkoxylated triglycamides, mixed ethers or mixed formals, alkyloligoglycosides, alkenyloligoglycosides, fatty acid N-alkylglucamides, phosphine oxides, dialkyl sulfoxides and protein hydrolyzates.

Typical examples of amphoteric or zwitterionic surfactants are alkylbetaines, alkylamidobetaines, aminopropionates, aminoglycinates or amphoteric imidazolinium compounds of the formula

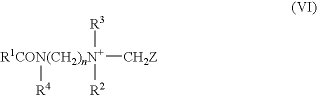

in which R¹ is C₈-C₂₂-alkyl or -alkenyl, R² is hydrogen or CH₂CO₂M, R³ is CH₂CH₂OH or CH₂CH₂OCH₂CH₂CO₂M, R⁴ is hydrogen, CH₂CH₂OH or CH₂CH₂COOM, Z is CO₂M or CH₂CO₂M, n is 2 or 3, preferably 2, M is hydrogen or a cation such as an alkali metal, alkaline earth metal, ammonium or alkanolammonium cation.

Preferred amphoteric surfactants of this formula are monocarboxylates and dicarboxylates. Examples thereof are cocoamphocarboxypropionate, cocoamidocarboxypropionic acid, cocoamphocarboxyglycinate (also referred to as cocoamphodiacetate) and cocoamphoacetate.

Further preferred amphoteric surfactants are alkyldimethylbetaines and alkyldipolyethoxybetaines with an alkyl radical having from approx. 8 to approx. 22 carbon atoms which may be linear or branched, preferably having from 8 to 18 carbon atoms and more preferably having from 12 to 18 carbon atoms.

Suitable cationic surfactants are substituted or unsubstituted, straight-chain or branched, quaternary ammonium salts of the R¹N(CH₃)₃⁺X⁻, R¹R²N(CH₃)₂⁺X⁻, R¹R²R³N(CH₃)⁺X⁻ or R¹R²R³R⁴N⁺X⁻ type. The R¹, R², R³ and R⁴ radicals are each independently preferably unsubstituted alkyl having a chain length of from 8 to 24 carbon atoms, in particular from 10 to 18 carbon atoms, hydroxyalkyl having from 1 to 4 carbon atoms, phenyl, C₂-C₁₈alkenyl, C₇-C₂₄-aralkyl, (C₂H₄O)ₓH where x is an integer from 1 to 3, alkyl radicals comprising one or more ester groups, or cyclic quaternary ammonium salts. X is a suitable anion known to those skilled in the art.

The organic solvent component (iv) may comprise one or more organic solvents, in which case at least one of these solvents, but preferably all solvents, are at least partly water-miscible. More preferably, there is complete miscibility with water in the desired concentration range.

The organic solvent component (iv) is preferably a mono- or polyhydric alcohol. It is at least preferred when such an alcohol is present in component (iv).

Examples of mono- or polyhydric alcohols are methanol, ethanol, n-propanol, i-propanol, n-butanol, sec-butanol, i-butanol, tert-butanol, glycols such as ethylene glycol, propylene glycol, dipropylene glycol, glycerol, polyalkylene glycols such as polyethylene glycol. Particular preference is given to methanol and ethanol. Very particular preference is given to methanol.

The melting point of component (i) is preferably in the range from 5° C. to 200° C.

Also preferred is a range from 10° C. to 100° C. More preferred is a range from 30° C. to 80° C. and especially preferred is a range from 40° C. to 60° C.

Accordingly, it is preferred that the first temperature range is in the range of more than 10° C. and less than 250° C. More preferably, the first temperature range is in the range of more than 30° C. and less than 200° C. More preferably, the first temperature range is in the range of more than 50° C. and less than 150° C. Especially preferably, the first temperature range is in the range of more than 60° C. and less than 100° C.

Furthermore, it is preferred that the second temperature range is in the range from more than 1° C. to less than 100° C. Also preferably, the second temperature range is in the range of more than 1° C. and less than 75° C. More preferably, the second temperature range is in the range of more than 1° C. and less than 60° C. Especially preferably, the second temperature range is in the range from 1° C. to less than 40° C.

Most preferably, the second temperature range is at room temperature.

In the selection of the first and second temperature range, however, it must be ensured that the melting point of the paraffin inhibitor component is below the temperature of the first temperature range and above the temperature of the second temperature range. When this is complied with, constant temperature in the course of addition of components is not required, but is preferred.

In the process according to the invention for preparing a paraffin inhibitor formulation, the component proportions are preferably selected so as to give rise to a paraffin inhibitor formulation in which the components (i) to (iv) are present with the following proportions by weight, based in each case on the total weight of the formulation:
(i) 10 to 70% by weight, more preferably 10 to 60% by weight, even more preferably 20 to 55% by weight, of paraffin inhibitor component;
(ii) 1 to 30% by weight, more preferably 1 to 20% by weight, even more preferably 1 to 10% by weight, of emulsifier component;
(iii) 1 to 89% by weight, more preferably 20 to 89% by weight, even more preferably 40 to 89% by weight, especially 45 to 80% by weight, of water;
(iv) 0 to 88% by weight, more preferably 1 to 80% by weight, more preferably 5 to 75% by weight, even more preferably 10 to 70% by weight, especially 20 to 60% by weight, of solvent component.

One advantage of the process according to the invention for preparing a paraffin inhibitor formulation is that the paraffin inhibitor component is present in the formulation in finely distributed form. The paraffin inhibitor component in the formulation preferably has a mean particle diameter of less than 100 μm. Even more preferably, a mean particle diameter of less than 10 μm and especially less than 1 μm is obtained. The low particle size prevents the particles from separating in spite of the low viscosity of the formulation, i.e. from floating and coagulating/coalescing.

The determination of the mean particle diameter can be determined by test methods known in the prior art. This can be done, for example, with the aid of light scattering.

It is appropriate that steps (a) to (d) in the process according to the invention to prepare a paraffin inhibitor formulation take place with stirring.

It may likewise be appropriate when a pH adjustment is effected before step (d). In this context, an alkaline pH range is preferred.

The inventive paraffin inhibitor formulation thus obtained may serve as an additive in oil or oil raffinates and in the transport or storage of crude oil or crude oil raffinates.

The inventive formulation can be used especially in a process for paraffin inhibition/pour point depression of crude oil or crude oil raffinates, this process comprising the step of:
adding an inventive formulation to crude oil or a crude oil raffinate, the crude oil or crude oil raffinate preferably having a temperature which is above the melting point of the paraffin inhibitor component.

It is preferred here that the formulation, before the addition, is heated to a temperature above the melting point of the paraffin inhibitor component. This can be effected, for example, with the aid of a flow heater.

### EXAMPLE

### Preparation Process

First, wax, surfactant and ⅓ of the required amount of pH-adjusted water are initially charged. These are heated to 85° C. and emulsified at 2000 rpm with a propeller stirrer (Janke & Kunkel 1 KA Werk RW20). After 10 minutes, the remaining water at 85° C. is added and the mixture is stirred for a further 5 minutes. Thereafter, the sample is cooled to room temperature (but at least below the melting point) at 700 rpm. Subsequently, the pH is checked and adjusted if appropriate. The pH of the water phase is adjusted with HCl or N,N-dimethylethanolamine.

A useful surfactant system has been found to be a C₁₆-C₁₈-fatty alcohol ethoxylate mixture with an HLB of approx. 15.

The wax used was the commercially available Basoflux PI 40®, which has a melting range of about 50° C.

After the cooling, the particle sizes were determined with the Beckman Coulter LS13 320 Laser Diffraction Particle Size analyzer.

This gave the following results:

| | X % of the | X % of the |
|---|---|---|
| Concentration of | particle | particle |
| Basoflux PI 40 | <1 μm | <5 μm |
| 50% by vol. | 49 | 100 |

### Storage Experiment:

Storage at 20° C. and at 60° C. over one week does not give any change in the particle size distribution. The product prepared in accordance with the invention remains stable.

When the components are merely emulsified at elevated temperature and stirred with a propeller stirrer in a noninventive process, what forms is a particle distribution which has relatively large particles, which is disadvantageous for the stability.

1.-15. (canceled)

16. A process for preparing a paraffin inhibitor formulation, comprising the steps of
(a) preparing a mixture comprising a waxy paraffin inhibitor component having a melting point of >0° C. and an emulsifier component, wherein the mixture is prepared at a first temperature range above the melting point of the waxy paraffin inhibitor;
(b) adding water to the mixture to produce an o/w emulsion; and
(c) cooling the o/w emulsion to a temperature in a second temperature range which is below the melting point of the waxy paraffin inhibitor.

17. The process of claim 16, wherein the waxy paraffin inhibitor comprises polymers based on ethylene/vinyl acetate, acrylic acid, methacrylic acid, olefin/maleic acid or the anhydride thereof or fatty acids which have been reacted with fatty alcohols or amines thereof to give esters, amides or imides.

18. The process of claim 16, wherein the emulsifier component comprises a nonionic surfactant or surfactant mixture.

19. The process of claim 16 further comprising (d) adding an at least partially water-miscible organic solvent component in which the waxy paraffin inhibitor is insoluble.

20. The process of claim 19, wherein the at least partially water-miscible organic solvent component comprises a mono- or polyhydric alcohol.

21. The process of claim 16, wherein the melting point of the waxy paraffin inhibitor is in the range from 5° C. to 200° C.

22. The process of claim 16, wherein the first temperature range is in the range of more than 10° C. and less than 250° C.

23. The process of claim 16, wherein the second temperature range is in the range of more than 1° C. and less than 100° C.

24. The process of claim 19, wherein the paraffin inhibitor formulation comprises the following components with the following proportions by weight, based in each case on the total weight of the formulation:
10 to 70% by weight of the waxy paraffin inhibitor component;
1 to 30% by weight of the emulsifier component;
1 to 89% by weight of water;
0 to 88% by weight of the organic solvent component,
wherein the proportion by weight of water is greater than the sum of the proportions by weight of components the waxy paraffin inhibitor component and the emulsifier component.

25. The process of claim 16, wherein the waxy paraffin inhibitor component has a mean particle diameter of <100 μm.

26. The process of claim 19, wherein steps (a) to (d) are effected with stirring.

27. The process of claim 19, further comprising adjusting the pH of the o/w emulsion before step (d).

28. The process of claim 16, wherein the mixture prepared in step (a) further comprises water to produce a w/o emulsion, the water being present in a proportion by weight that is lower than the sum of the proportions by weight of the waxy paraffin inhibitor and the emulsifier component.

29. A paraffin inhibitor formulation obtainable from the preparation processes according to claim 16.

30. A process for paraffin inhibition/pour point depression of a crude oil or crude oil raffinates, comprising adding the formulation of claim 29 to the crude oil or crude oil raffinates.

31. The process of claim 30, wherein the formulation is heated to a temperature above the melting point of the paraffin inhibitor component before the step of adding the formulation of claim 28 to the crude oil or crude oil raffinates.
